(19) United States
(12) Patent Application Publication
(10) Pub. No.: US 2026/0235343 A1
(43) Pub. Date: Aug. 13, 2026

(54) ICE-LIKE SNOW PREPARATION VEHICLE, FINAL ASSEMBLY AND CALCULATION METHOD OF WATER AMOUNT INJECTED INTO TARGET POSITION BY ICE-LIKE SNOW PREPARATION VEHICLE

(71) Applicant: Northwest Institute of Eco-Environment and Resources, Chinese Academy of Sciences, Lanzhou (CN)

(72) Inventors: Haidong Han, Lanzhou (CN); Feiteng Wang, Lanzhou (CN)

(21) Appl. No.: 19/072,115

(22) Filed: Mar. 6, 2025

(30) Foreign Application Priority Data
Feb. 10, 2025 (CN) 2025101452292

(51) Int. Cl. F25C 3/04

(52) U.S. Cl. CPC F25C 3/04; F25C 2303/048

(57) ABSTRACT

An ice snow preparation vehicle includes a vehicle frame including a ski; a water injection assembly including a water pump, a fixing plate defining limiting holes, a water dividing plate defining water passages and multiple water injection pipes assembled on the water dividing plate; a push-pull mechanism, configured to drive the water dividing plate to move reciprocally in a height direction of a vehicle frame; a pressure sensor configured to obtain pressure of target snow layers; and a controller, configured to calculate water replenishment amounts of target snow layers according to the pressure of target snow layers. When the water dividing plate is driven by the push-pull mechanism to drive the water injection pipes to move downwards, ends of water injection pipes penetrate through corresponding limiting holes and extend into each target snow layer, to replenish a certain amount of water into each target snow layer.

### TECHNICAL FIELD

The disclosure relates to the field of artificial snow making technologies, and more particularly to an ice-like snow preparation vehicle, an ice-like snow preparation final assembly and a calculation method of a water amount injected into a target position by an ice-like snow preparation vehicle.

### BACKGROUND

Ice-like snow refers to snow cover with a density in a range of 0.60 grams per cubic centimeter (g/cm³) to 0.68 g/cm³, which has features of hard texture, coarse snow particles, and low porosity, and is mainly applied to competition events such as ski-jumping and alpine downhill in an alpine skiing venue (based on considerations such as competition fairness, comparability of results, and viewing of the event).

Due to features of fast speed, strong impact on the track, and large snow disturbance in alpine skiing, when the snow surface is loose, disturbance generated by front athletes on the track will interfere with competition of rear athletes. Therefore, the alpine skiing requires the use of ice-like snow tracks with hard texture and impact resistance to ensure that physical quantities such as smoothness, density, and friction coefficient of the track remain unchanged during the competition. That is to say, the aforementioned physical quantities on the ice-like snow tracks during the competition are the same for each athlete to maintain fairness in the competition.

For the preparation of the ice-like snow tracks, there is no corresponding automated mechanical devices, and it is usually achieved through manual preparation. The steps for manually preparing the ice-like snow tracks are as follows. (1) A snow compactor is used to flatten and compact the snow made by a snow making machine or crushed ice to form an ordinary track with a thickness of not less than 70 centimeters (cm), and then a snow density or hardness tester is used to evaluate density spatial distribution of the track. (2) For a racing track, it is also necessary to use the snow compactor to break open the ordinary track, and a required water injection volume is calculated based on the density of the ordinary track evaluated in the previous step. After injecting water in batches, the ordinary track is repeatedly broken open and pressing to evenly distribute the snow in the track, and then the snow is quickly flattened and left to wait for the ice-like snow track to be in a uniformly frozen state. (3) After the preparation of the ice-like snow track is completed, it is necessary to manually shovel the floating snow on the ice-like snow track in a side sliding manner using skis, so that the repaired ice-like snow track can achieve a mirror like surface smoothness. Apparently, the aforementioned method of manually preparing ice-like snow tracks has disadvantages such as consuming manpower and resources, low efficiency, and inability to ensure the compliance of artificially made ice-like snow tracks.

Based on this, the disclosure provides an ice-like snow preparation vehicle, a final assembly and a calculation method of water volume injected into a target position of ice-like snow preparation vehicle to solve the aforementioned technical problem.

### SUMMARY

The technical problem to be solve by the disclosure is how to achieve automated preparation of ice-like snow. Aiming at the aforementioned problem, the disclosure provides an ice-like snow preparation vehicle, an ice-like snow preparation final assembly and a calculation method of a water amount injected into a target position by an ice-like snow preparation vehicle.

The technical solution of the disclosure to solve the aforementioned technical problem is to provides an ice-like snow preparation vehicle, including a vehicle frame, a water injection assembly, a push-pull mechanism, a temperature-pressure sensing element, and a controller.

The vehicle frame includes a ski. The water injection assembly includes a fixing plate, a water dividing plate and multiple water injection pipes. The fixing plate is mounted on the ski. The water dividing plate is supported on the fixing plate. The multiple water injection pipes are assembled on the water dividing plate. The fixing plate defines multiple limiting holes penetrating through the fixing plate along a thickness direction and matched with a number of the multiple water injection pipes. Along the thickness direction of the water dividing plate, the water dividing plate defines multiple water passages connected to the multiple water injection pipes. The push-pull mechanism is configured to drive the water dividing plate to move reciprocally in a height direction of the vehicle frame, and a height of an end of the push-pull mechanism hinged on a peripheral side of the vehicle frame from ground is greater than a height of an end of the push-pull mechanism hinged on a top of the water dividing plate from the ground. The temperature-pressure sensing element includes a pressure sensor configured to obtain pressure of each target snow layer in a snow block to be prepared into ice-like snow. The controller is configured to calculate a water replenishment amount of each target snow layer according to the pressure of each target snow layer in the snow block to be prepared into ice-like snow. When the water dividing plate is driven by the push-pull mechanism to drive the multiple water injection pipes to synchronously move downwards, an end of each water injection pipe penetrates through a corresponding one of the multiple limiting holes and extending into each target snow layer, to thereby replenish a certain amount of water into each target snow layer in the snow block to be prepared into ice-lick snow.

In an embodiment, an extension direction of a part of the multiple water passages is the same as a length direction of the water dividing plate, and an extension direction of another part of the multiple water passages is the same as a width direction of the water dividing plate.

The part of the multiple water passages are arranged on the water dividing plate in an array along the length direction of the water dividing plate, and the another part of the multiple water passages are arranged on the water dividing plate in an array along the width direction of the water dividing plate.

A bottom surface of the water dividing plate defines multiple first mounting holes, each first mounting hole is configured to connect a corresponding one of the multiple water injection pipes, and an end of each first mounting hole is connected to a corresponding one of the multiple limiting holes, and another end of each first mounting hole is connected to a corresponding one of crossing areas formed by the part of the multiple water passages in the width direction and the another part of the multiple water passages in the length direction.

In an embodiment, one of the crossing areas on a middle area of the water dividing plate defines a second mounting hole, and a head end of the temperature-pressure sensing element is mounted in the second mounting hole.

The temperature-pressure sensing element is a temperature-pressure detecting rod; and a difference d between a length of the temperature-pressure detecting rod and a length of each water injection pipe is greater than or equal to 10 centimeters (cm) and smaller than or equal to 20 cm.

In an embodiment, each water injection pipe includes a pipe body and a water injection head fixed on a tail of the pipe body, and a peripheral side of a part the pipe body proximate to the water injection head is covered with a thermal insulation element.

A surface of the water injection head defines multiple water injection holes, and a diameter d of an opening of each water injection hole is greater than or equal to 0.2 millimeters (mm) and small than or equal to 0.5 mm.

In an embodiment, the water injection head includes a cylindrical section and a tip section connected to an end of the cylindrical section, and a diameter of the cylindrical section is greater than that of the thermal insulation element.

In an embodiment, a shape of a head of the temperature-pressure sensing element is conical.

In an embodiment, an ice-like snow preparation final assembly is provided, which includes a snow compactor and the aforementioned ice-like snow preparation vehicle. The ice-like snow preparation vehicle is configured to move to a specified location driven by the snow compactor.

In an embodiment, a calculation method of a water amount injected into a target position by an ice-like snow preparation vehicle is provided, which is applied to the aforementioned ice-like snow preparation vehicle, and includes:
calculating a hardness value of each target snow layer in the snow block to be prepared into ice-like snow according to the pressure of each target snow layers in the snow block to be prepared into ice-like snow;
calculating a density of each target snow layer in the snow block to be prepared into ice-like snow according to the hardness value of each target snow layer in the snow block to be prepared into ice-like snow using a formula expressed as follows:

$$ρ = ( P + 685.16 ) / 2.5058 \times 1 {0}^{3} ;$$

where P represents the hardness value of each target snow layer in the snow block to be prepared into ice-like snow, and ρ represents the density of each target snow layer in the snow block to be prepared into ice-like snow;
calculating a theoretical water replenishment rate of each target snow layer in the snow block to be prepared into ice-like snow according to the density of each target snow layer in the snow block to be prepared into ice-like snow using a formula expressed as follows:

$$R = \frac{{ρ}_{ice} - ρ}{{ρ}_{water}} ;$$

where ρ_{ice} represents an expected density of each target snow layer in the snow block to be prepared into ice-like snow; ρ_{water} represents a density of water; and R represents the theoretical water replenishment rate of each target snow layer in the snow block to be prepared into ice-like snow; and
calculating a theoretical water replenishment amount of each target snow layer in the snow block to be prepared into ice-like snow.

In an embodiment, the calculation method further includes:
calculating an actual water replenishment rate of each target snow layer in the snow block to be prepared into ice-like snow according to a temperature of each target snow layer in the snow block to be prepared into ice-like snow obtained by the temperature-pressure sensing element using a formula expressed as follows:

$$\{ \begin{matrix}{R}_{i}^{′} = 1.2 {R}_{i} & i = 1 \\ {R}_{i}^{′} = {R}_{i} - {aR}_{i - 1} \frac{{T}_{w}}{{T}_{w} - {T}_{i}} & i > 1\end{matrix} ;$$

where

$${R}_{i}^{′}$$

represents an actual water replenishment rate of an i^{th} target snow layer, Rᵢ represents a theoretical water replenishment rate of the i^{th} target snow layer, T_{w} represents a water injection temperature, Tᵢ represents a temperature of the i^{th} target snow layer, and a represents an empirical coefficient.

In an embodiment, the calculation method further includes:
calculating a water replenishment amount of each target snow layer in the snow block to be prepared into ice-like snow according to a product of the actual water replenishment rate of each target snow layer in the snow block to be prepared into ice-like snow and a volume of each target snow layer in the snow block to be prepared into ice-like snow.

The beneficial effects of the disclosure are as follows. The water replenishment amount of each target snow layer is calculated by controlling the water pump and according to the pressure of each target snow layer in the snow block to be prepared into ice-like snow, when the water dividing plate is driven by the push-pull mechanism to drive the multiple water injection pipes to synchronously move downwards, the end of each water injection pipe penetrates through a corresponding one of the multiple limiting holes and extends into each target snow layer, to thereby replenish a certain amount of water into each target snow layer in the snow block to be prepared into ice-lick snow.

### BRIEF DESCRIPTION OF DRAWINGS

FIG. 1 illustrates a schematic structural diagram of an ice-like snow preparation final assembly according to an embodiment of the disclosure.

FIG. 2 illustrates a schematic structural diagram of an ice-like snow preparation vehicle in a state according to an embodiment of the disclosure.

FIG. 3 illustrates a schematic structural diagram of the ice-like snow preparation vehicle in another state according to an embodiment of the disclosure.

FIG. 4 illustrates a schematic structural diagram of a vehicle frame of the ice-like snow preparation vehicle according to an embodiment of the disclosure.

FIG. 5 illustrates a schematic structural diagram of a water dividing plate, water injection pipes and a temperature-pressure sensing element of the ice-like snow preparation vehicle according to an embodiment of the disclosure.

FIG. 6 illustrates a schematic structural diagram of the water dividing plate of the ice-like snow preparation vehicle an embodiment of the disclosure.

FIG. 7 illustrates a schematic sectional diagram of A-A in FIG. 6 according to the disclosure.

FIG. 8 illustrates a schematic sectional diagram of B-B in FIG. 6 according to the disclosure.

FIG. 9 illustrates a schematic structural diagram of the water injection pipe of the ice-like snow preparation vehicle according to an embodiment of the disclosure.

FIG. 10 illustrates a schematic diagram of a summary table of existing hardness testing equipment (Ren Zaichao, Technical Improvement and Experimental Research of Snow Penetration Meter, Dalian University of Technology, 2021).

FIG. 11 illustrates a schematic diagram of a water injection pressure sequence curve of a water pump of target snow layers.

### DESCRIPTION OF REFERENCE SIGNS

1—ice-like snow preparation vehicle; 10—vehicle frame; 100—ski; 1000—guide groove; 101—bracket; 102—upright column; 103—pulley structure; 104—high position limit switch; 105—low position limit switch;
11—water injection assembly; 110—water pump; 111—fixing plate; 1110—limiting hole; 112—water dividing plate; 1120—water passage; 1121—first mounting hole; 1122—second mounting hole; 113—water injection pipe; 1130—pipe body; 1131—water injection head; 1131a—water injection hole; 1131b—cylindrical section; 1131c—tip section; 1132—thermal insulation element;
12—push-pull mechanism; 13—temperature-pressure sensing element; 14—control cabin; 140—controller; 15—water pump cabin; 16—water tank; 17—water diversion pipe; 18—draft arm; 2—snow compactor; 3—snow block to be prepared into ice-like snow.

### DETAILED DESCRIPTION OF EMBODIMENTS

In order to make objective, technical solution and advantages more clear, the disclosure will be further described in detail in conjunction with drawings and embodiments. It should be understood that the described embodiments here are merely used to explain the disclosure, and are not used to limit the disclosure.

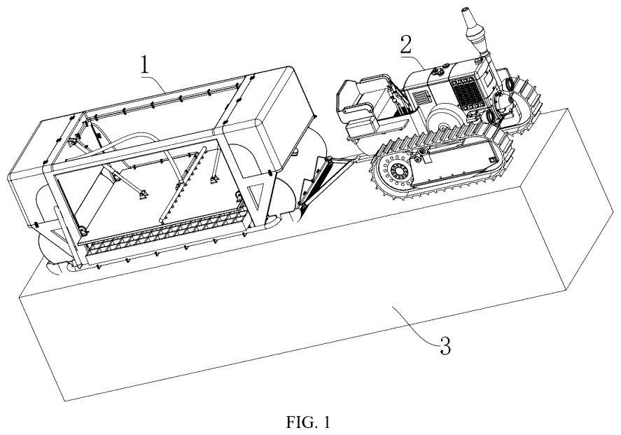

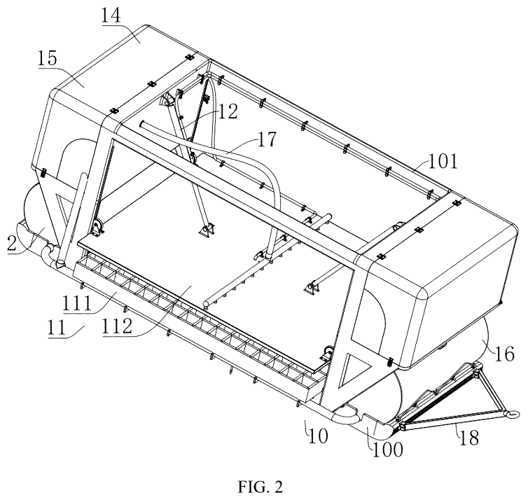

Referring to FIG. 1 and FIG. 2, the disclosure provides an ice-like snow preparation vehicle 1, including a vehicle frame 10, a water injection assembly 11, a push-pull mechanism 12, a pressure sensor and a controller 140. The water injection assembly 11 is disposed on the vehicle frame 10. The push-pull mechanism 12 is configured to push and pull a water dividing plate 112 in the water injection assembly 11. A pressure value of a snow block 3 to be prepared into ice-like snow is obtained through the pressure sensor to thereby calculate a predetermined water injection pressure for injecting water into the water dividing plate 112, and driven by the push-pull mechanism 12, a certain volume of water will be replenished into the snow block 3 to be prepared into ice-like snow through the water dividing plate 112.

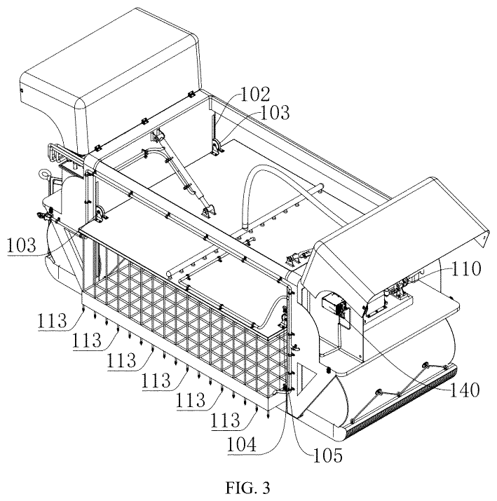

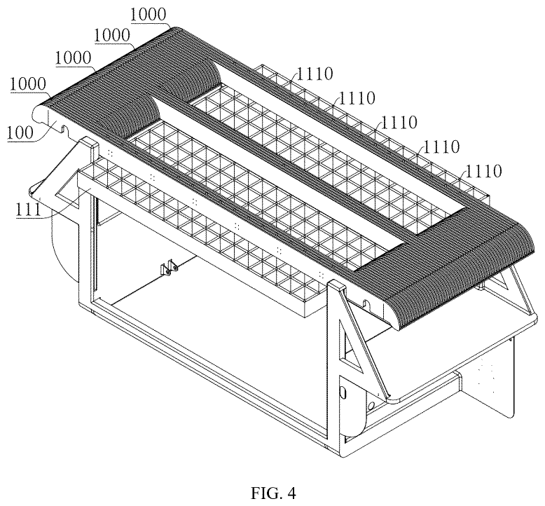

As shown in FIG. 3 and FIG. 4, the vehicle frame 10 includes a ski 100. A bottom of the ski 100 bends from a middle to both ends, and an opening direction of the ski 100 is facing away from the ground direction, to thereby reduce resistance of the ice-like snow preparation vehicle 1 during movement. Specifically, the bottom of the ski 100 can define multiple guide grooves 1000, and a length direction of each guide groove 1000 is parallel to a length direction of the ski 100, so as to assist the ice-like snow preparation vehicle 1 to slide on a surface of the snow block 3 to be prepared into ice-like snow, and ensure stability of the ice-like snow preparation vehicle 1 at the same time. More specifically, a width d and a depth h of each guide groove 1000 can satisfy: 2 cm≥d≥1 cm and 2 cm≥h≥1 cm.

The water injection assembly 11 includes a water pump 110, a fixing plate 111, the water dividing plate 112 and multiple water injection pipes 113. The fixing plate 111 is mounted on the ski 100, the water dividing plate 112 is supported on the fixing plate 111, and the multiple water injection pipes 113 are disposed on the water dividing plate 112. Optionally, the ice-like snow preparation vehicle 1 can further include a bracket 101, the bracket 101 is mounted on the ski 100 and configured to support a water pump cabin 15 and a control cabin 14, and the water pump 110 and the controller 140 are placed in the water pump cabin 15 and the control cabin 14 respectively. The fixing plate 111 defines multiple limiting holes 1110 penetrating through the fixing plate 111 along a thickness direction and are matched with a number of the multiple water injection pipes 113. The water dividing plate 112 defines multiple water passages 1120 connected to the multiple water injection pipes 113 along a thickness direction of the water dividing plate 112. Apparently, each water injection pipe 113 extends downwards through a corresponding limiting hole 1110. In an embodiment, in order to reduce resistance of each water injection pipe 113 to be inserted into the snow block 3 to be prepared into ice-like snow, a shape of each water injection pipe 113 can be cylindrical, correspondingly, each limiting hole 1110 can be a circular through-hole.

It should be noted that when the ice-like snow preparation vehicle 1 is in a non-working state, a water injection head 1131 (please refer to the following for details) of each water injection pipe 113 is accommodated in the corresponding limiting hole 1110. In order to prevent the water in the water injection head 1131 from freezing during this process, insulated electric heating wires are installed in each limiting hole 1110 for protection.

In a specific embodiment, the fixing plate 111 defines multiple square through-holes in an array along the thickness direction of the fixing plate 111, and defines the limiting holes 1110 on intersecting areas of multiple crisscrossing rib plates. A side length dimension d of each square through-hole can satisfy: 20 cm≥d≥15 cm. Certainly, in other specific embodiments, the limiting holes 1110 can be other shape and/or dimension. A diameter d of the limiting hole 1110 can satisfy: 2 cm≥d≥4 cm.

The push-pull mechanism 12 can drive the water dividing plate 112 to move reciprocally in a height direction of the vehicle frame 10, a height value of an end of the push-pull mechanism 12 hinged on a peripheral side of the vehicle frame 10 from ground is greater than a height value of an end of the push-pull mechanism 12 hinged on a top of the water dividing plate 112 from the ground, to thereby adjust depths of the multiple water injection pipes 113 on the water dividing plate 112 extending into the snow block 3 to be prepared into ice-like snow. In an embodiment, the push-pull mechanism 12 can be a hydraulic push rod, a cylinder push rod, an electric push rod or a screw push rod.

The temperature pressure sensing element 10 includes a pressure sensor configured to obtain pressure of each target snow layer (multilayer, please refer to the following for detail) in the snow block 3 to be prepared into ice-like snow. Here, it should be noted that during the ice-like snow preparation vehicle 1 prepares the ice-like snow, it is necessary to calculate a thickness of each target snow layer based on a lifting speed of the water dividing plate 112 and sampling frequency of the controller 140, multiple water injection pipes 113 are used to sequentially inject water into each target snow layer from the topmost target snow layer to the bottom target snow layer in the snow block 3 to be prepared into ice-like snow until an end of each water injection pipe 113 reaches a target position of the bottommost or bottommost target snow layer in the snow block 3 to be prepared into ice-like snow. Apparently, the water injection pipes 113 are used to inject water into the entire target snow layers at the target position (or in other words, the water injection location, which is at a bottom of the target snow layers).

It should be further noted that the aforementioned snow layers are imaginary features for the convenience of describing that the water injection pipe 113 sequentially injects water into multiple small snow blocks (the small snow blocks are stacked layer by layer along a thickness direction to form the snow block 3 to be prepared into ice-like snow) with a same volume in a process of downward movement (referring to the following detail) of the water injection assembly 11. Specifically, the multiple small snow blocks correspond to different target snow layers.

The controller 140 is configured to calculate a water replenishment amount of each target snow layer according to the pressure of each target snow layer in the snow block 3 to be prepared into ice-like snow obtained by the pressure sensor. At the same time, the water pump 110 is controlled to inject water (the water injected into the water dividing plate 113 is replenished into the target snow layers through the water injection pipes 113) into the water dividing plate 112 in a predetermined water injection pressure (the calculation method refers to the following) of the water pump 110, thereby indirectly operating water injection amount (i.e., the water replenishment amount required for the target snow layers) of the water pump 110 injected into the water dividing plate 112. Synchronously, during the controller 140 controls the push-pull mechanism 12 to drive the water dividing plate to move downwards, and the water dividing plate 112 drives the multiple water injection pipes 113 to move downwards, the water injection heads 1131 of the multiple water injection pipes 113 penetrate through the corresponding limiting holes 1110 to extend into each target snow layer of the snow block 3 to be prepared into ice-like snow, and at the same time, a certain amount of water is replenishment into each target snow layer.

It should be noted that, as mentioned earlier, this refers to multiple water injection pipes 113 sequentially injecting a certain amount of water into each target snow layer from the topmost target snow layer to the bottom target snow layer in the snow block 3 to be prepared into ice-like snow. That is to say, the water injection pipes 113 inject the required amount of water into the target snow layer. Therefore, the water injection or replenishment amount required for different target snow layers is usually different.

In an embodiment, the vehicle frame 10 is assembled from multiple upright columns 102, and each upright column 102 is mounted with a pulley structure configured to drive the water dividing plate 112 to achieve lifting motion. A high position limit switch 104 and a low position limit switch 105 are disposed on one of the upright columns 102, the water dividing plate 112 is located between the high position limit switch 104 and the low position limit switch 105, and a position of the water dividing plate 112 is adjusted through the high position limit switch 104 and the low position limit switch 105, so that the water injection pipes 113 is at the target position driven by the water dividing plate 112. It can be understood that distances between the high position limit switch 104 and the low position limit switch 105 relative to a surface of the snow block 3 to be prepared into ice-like snow can be adjusted, to achieve the purpose of injecting water into the snow block 3 to be prepared into ice-like snow with different thicknesses. Certainly, in other embodiments, the lifting motion of the water dividing plate 112 can be achieved through other means.

In an embodiment, the ice-like snow preparation vehicle 1 can further include a water tank 16 and a water diversion pipe 17, which can not only supply water to the water pump 110, but also provide sufficient weight for the ice-like snow preparation vehicle 1, thereby ensuring the stability of the ice-like snow preparation vehicle 1 in moving. Apparently, an end of the water diversion pipe 17 is connected to a water outlet of the water tank 16, and another end of the water diversion pipe 17 is connected to a water inlet of the water pump 110. Specifically, a heating device and a temperature sensor can be mounted in the water tank 16, so that a temperature of water is kept at 10 Celsius degrees (° C.) to 15° C., to prevent freezing of water with low water temperature during transportation or injection, which may cause malfunction of the ice-like snow preparation vehicle 1 or uneven injection amount of water into different target snow layers of the snow block 3 to be prepared into ice-like snow; and to prevent water with excessively high water temperature from forming voids and discontinuous ice bodies (it can also lead to uneven injection of water as mentioned earlier) when injected into the snow block 3 to be prepared into ice-like snow. In an embodiment, in order to prevent the water in the water tank 16 and the water diversion pipe 17 from freezing, insulation layers are wrapped around the water tank 16 and water diversion pipe 17.

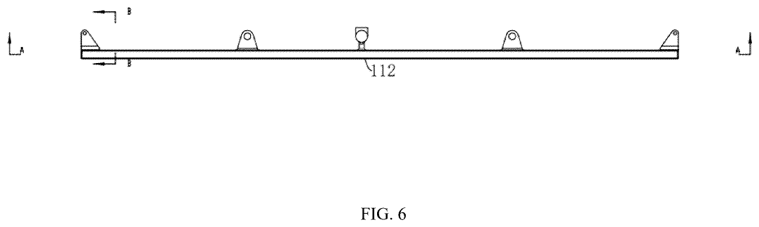

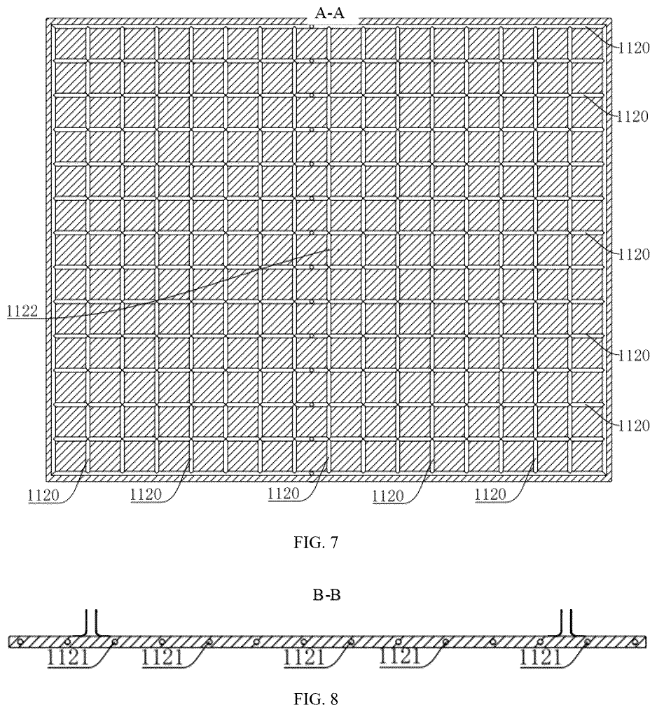

In a specific embodiment, referring to FIG. 6, FIG. 7 and FIG. 8, an extension direction of a part of the multiple water passages 1120 is the same as a length direction of the water dividing plate 112, and an extension direction of another part of the multiple water passages 1120 is the same as a width direction of the water dividing plate 112. In the specific embodiment, a shape of the water dividing plate 112 can be rectangular, that is to say, a number of the water passages 1120 with the same extension direction as the length direction of the water dividing plate 112 is greater than a number of the water passages 1120 with the same extension direction as the width direction of the water dividing plate 112.

Along the length direction of the water dividing plate 112, a part of the multiple water passages 1120 is arranged on the water dividing plate 112 in an array; and along the width direction of the water dividing plate 112, another part of the water passages 1120 is also arranged on the water dividing plate 112 in an array, to thereby form multiple crossing areas. A bottom surface of the water dividing plate 112 further defines multiple first mounting holes 1121 configured to connect corresponding water injection pipes 113, an end of each first mounting hole 1121 is connected to (when the fixing plate 111 supports the water dividing plate 112) the corresponding limiting hole 1110, and another end of the first mounting hole 1121 is connected to a corresponding crossing area formed by multiple water passages 1120 in the width direction of the water dividing plate 112 and multiple water passages 1120 in the length direction of the water dividing plate 112, to facilitate transportation of water from the water tank 16 to each water injection pipe 113 through the water passages 1120 under the drive of the water pump 110. In the specific embodiment, each water injection pipe 113 is connected to the corresponding first mounting hole 1121 in a threaded manner.

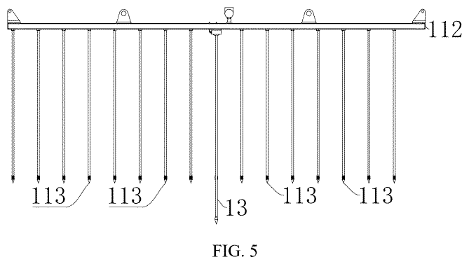

In a specific embodiment, a crossing area on a middle of the water dividing plate 112 defines a second mounting hole 1122, and a top end of the pressure sensor is mounted in the second mounting hole 1122. In the specific embodiment, as shown in FIG. 5, in order to insert the temperature-pressure sensing element 13 into each target snow layer in the snow block 3 to be prepared into ice-like snow before the water injection pipe 113, to obtain a hardness value and a temperature value of each target snow layer, a difference d between the length of the temperature-pressure sensing element 13 and a length of the water injection pipe 113 can satisfy: 10 cm≤d≤20 cm. Apparently, the temperature-pressure sensing element 13 can be a temperature-pressure detecting rod.

In a specific embodiment, the temperature-pressure sensing element 13 further includes a temperature sensor (referring to the following for details) used to obtain the temperature of each target snow layer of the snow block 3 to be prepared into ice-like snow.

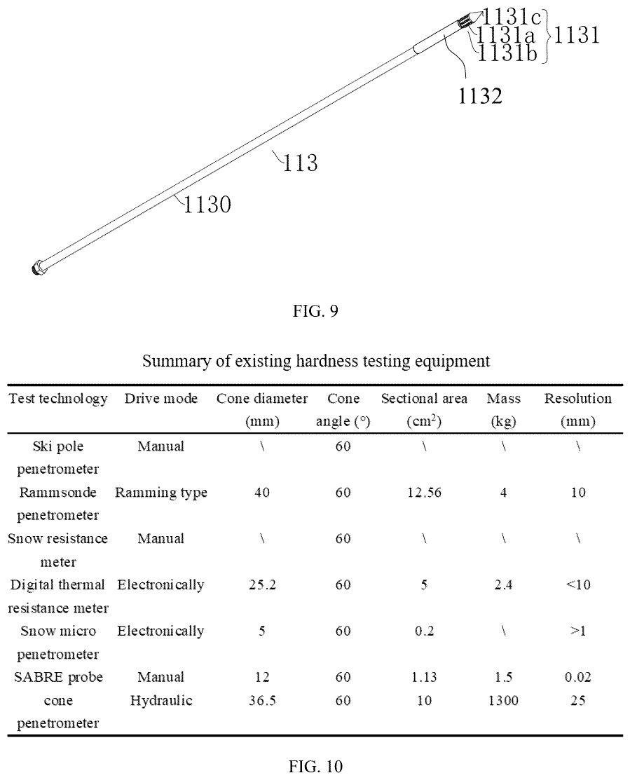

In a specific embodiment, as shown in FIG. 9, each water injection pipe 113 includes a pipe body 1130 and a water injection head 1131 fixed on a tail of the pipe body 1130. In order to prevent the water in the water injection pipe 113 from freezing, a peripheral side of a part of the pipe body 1130 proximate to the water injection head 1131 is covered with a thermal insulation element 1132. In the specific embodiment, the thermal insulation element 1132 can be a thermal insulation tube.

A surface of the water injection head 1131 defines multiple water injection holes 1131a. In order to prevent the multiple water injection holes 1131a from being blocked, and avoid damaging the target snow layers in the snow block 3 to be prepared into ice-like snow or wasting water due to the large size of the water injection holes 1131a, a diameter d of an opening of each water injection hole 1131a can satisfy: 0.2 mm≤d≤0.5 mm.

In a specific embodiment, in order to decrease resistance of the water injection pipes 113 to be inserted into the snow block 3 to be prepared into ice-like snow, each water injection head 1131 includes a cylindrical section 1131b and a tip section 1131c connected to an end of the cylindrical section 1131b, and a diameter of the cylindrical section 1131b is greater than that of the thermal insulation element 1132.

In a specific embodiment, a head of the temperature-pressure sensing element 13 is tapered. As shown in FIG. 10, in order to facilitate the conversion between the pressure of the target snow layers and the hardness of the target snow layers, it is necessary to select the values of cone angle and cone base diameter in the summary of existing hardness testing equipment. In the specific embodiment, the cone angle of the temperature-pressure sensing element 13 is 60 degrees (°), and a valuing range of the cone base diameter d is that 40 mm≥d≥25 mm.

In a specific embodiment, an ice-like snow preparation final assembly is provided, including a snow compactor 2 and the aforementioned ice-like snow preparation vehicle 1. The ice-like snow preparation vehicle 1 can move to a specified location driven by the snow compactor 2. In an embodiment, the ice-like snow preparation vehicle 1 can further include a draft arm 18 for connecting the snow compactor 2.

In a specific embodiment, a calculation method of a water amount injected into different target snow layers in a snow block to be prepared into ice-like snow (i.e., a calculation method of a water amount injected into a target position by an ice-like snow preparation vehicle) is provided, which is applied to the aforementioned ice-like snow preparation vehicle 1. Firstly, a hardness value of each target snow layer in the snow block 3 to be prepared into ice-like snow is calculated according to the pressure of each target snow layer in the snow block 3 to be prepared into ice-like snow using a formula expressed as follows:

$$P = \frac{F}{1000 \cdot π {r}^{2}} ;$$

where F represents the pressure of each target snow layer in the snow block 3 to be prepared into ice-like snow, and r represents a cone base diameter of a pressure sensor.

A density of each target snow layer in the snow block 3 to be prepared into ice-like snow is calculated according to the hardness of each target snow layer in the snow block 3 to be prepared into ice-like snow using formulas expressed as follows:

$$ρ = ( P + 685.16 ) / 2.5058 \times 1 {0}^{3} ;$$

$${R}^{2} = 0.987 .$$

The formulas are obtained by linear fitting of a large amount of experimental data. Specifically, R² represents a fitting degree of a sample; R²=1 represents a completely correlated scatter plot presenting a standard straight line; R²=0 represents that there is no linear relationship between the two; an actual value of p is calculated according to P, the closer the R² value is to 1, the better the fitting effect. That is to say, the closer the value of p is to the actual value by using P. P represents the hardness of each target snow layer in the snow block 3 to be prepared into ice-like snow, and p represents the density of each target snow layer in the snow block 3 to be prepared into ice-like snow. A theoretical water replenishment rate is calculated by the density of each target snow layer in the snow block 3 to be prepared into ice-like snow using a formula expressed as follows:

$$R = \frac{{ρ}_{ice} - ρ}{{ρ}_{water}} ;$$

where ρ_{ice} represents an expected density of teach target snow layer in the snow block 3 to be prepared into ice-like snow; ρ_{water} represents a density of water; and R represents the theoretical water replenishment rate of each target snow layer in the snow block 3 to be prepared into ice-like snow. A theoretical water replenishment amount of each target snow layer in the snow block 3 to be prepared into ice-like snow is calculated.

In a specific embodiment, since the temperature of the target snow layers will affect a vertical infiltration distance and a horizontal diffusion distance of the water during injecting water into the target snow layers in the snow block 3 to be prepared into ice-like snow, in order to more accurately calculate the water replenishment amount of each target snow layer in the snow block 3 to be prepared into ice-like snow, it is also necessary to calculate an actual water replenishment rate according to the temperature (obtained by the temperature sensor in the temperature-pressure sensing element 13, and the temperature sensor is not illustrated in drawings) of each target snow layer in the snow block 3 to be prepared into ice-like snow and formulas expressed as follows:

$$\{ \begin{matrix}{R}_{i}^{′} = 1.2 {R}_{i} & i = 1 \\ {R}_{i}^{′} = {R}_{i} - {aR}_{i - 1} \frac{{T}_{w}}{{T}_{w} - {T}_{i}} & i > 1\end{matrix} ;$$

where

$${R}_{i}^{′}$$

represents an actual wat replenishment rate of an i^{th} target snow layer, Rᵢ represents a theoretical water replenishment rate of the i^{th} target snow layer, T_{w} represents a water injection temperature, Tᵢ represents a temperature of the i^{th} target snow layer, and a represents an empirical coefficient.

In a specific embodiment, a water replenishment amount of each target snow layer in the snow block 3 to be prepared into ice-like snow is calculated according to a product of the actual water replenishment rate of each target snow layer in the snow block 3 to be prepared into ice-like snow and a volume of each target snow layer in the snow block 3 to be prepared into ice-like snow. Referring to the foregoing, it needs to calculate a thickness of each target snow layer according to a lifting speed of the water dividing plate 112 and sampling frequency of the controller 140. Here are some examples to illustrate, for example, when a moving speed of the water injection assembly 11 is 6 centimeters per second (cm/s, i.e., a distance traveled per second is 6 cm), and the sampling frequency of the controller 140 is 5 hertz (Hz, i.e. there are 5 sampling points per second), thus, the thickness of each target snow layer in the snow block 3 to be prepared into ice-like snow is 6 cm/s*5 Hz, which is equal to 1.2 cm. Here is an example of how to calculate a volume of each target snow layer in the snow block 3 to be prepared into ice-like snow. Firstly, assuming that horizontal and vertical intervals between two adjacent water injection pipes 113 are 20 cm, the volume of each target snow layer covered by water transported by each water injection pipe 113 is 20 cm×20 cm×1.2 cm=480 cubic centimeters (cm³). When the ice-like snow preparation vehicle 1 is mounted with 238 water injection pipes 113, the volume of each target snow layer in the snow block 3 to be prepared into ice-like snow is 238×480 cm³=114240 cm³.

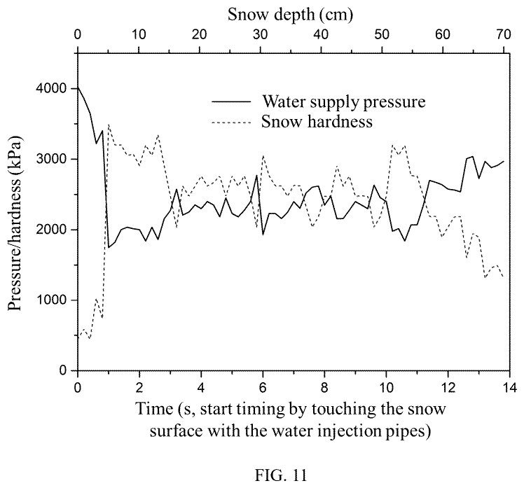

Based on this, the controller 140 can calculate the water injection amount of each target snow layers in the snow block 3 to be prepared into ice-like snow, then calculate water injection pressure of the water pump of the target snow layers according to a flow-pressure relationship (each type of the water pump has a specific flow-pressure relationship) of the water pump 110, and generate a water injection pressure sequence curve of the water pump of the target snow layers, which is shown in FIG. 11. When the water injection pipes 113 move to the target snow layers, it can determine the water injection pressure of the water pump based on the water injection pressure sequence curve to inject water into the target snow layers, thereby preparing uniform ice-like snow target snow layer on the thickness direction of the snow block 3 to be prepared into ice-like snow.

The above is merely some of the embodiments of the disclosure, but the scope of protection of the disclosure is not limited to this. Any changes or substitutions that can be easily thought of by those skilled in the art within the scope of the disclosed technology should be included in the scope of protection of the disclosure. Therefore, the scope of protection of the disclosure should be based on the scope of protection of the claims.

What is claimed is:

1. An ice-like snow preparation vehicle, comprising:
a vehicle frame, comprising a ski;
a water injection assembly, comprising:
a fixing plate, mounted on the ski;
a water dividing plate, supported on the fixing plate; and
a plurality of water injection pipes, assembled on the water dividing plate;
wherein the fixing plate defines a plurality of limiting holes penetrating through the fixing plate along a thickness direction and matched with a number of the plurality of water injection pipes, and along a thickness direction of the water dividing plate, the water dividing plate defines a plurality of water passages connected to the plurality of water injection pipes;
a push-pull mechanism, configured to drive the water dividing plate to move reciprocally in a height direction of the vehicle frame, wherein a height of an end of the push-pull mechanism hinged on a peripheral side of the vehicle frame from ground is greater than a height of an end of the push-pull mechanism hinged on a top of the water dividing plate from the ground;
a temperature-pressure sensing element, configured to obtain pressure of each target snow layer in a snow block to be prepared into ice-like snow; and
a controller, configured to calculate a water replenishment amount of each target snow layer according to the pressure of each target snow layer in the snow block to be prepared into ice-like snow, when the water dividing plate is driven by the push-pull mechanism to drive the plurality of water injection pipes to synchronously move downwards, an end of each of the plurality of water injection pipes penetrating through a corresponding one of the plurality of limiting holes and extending into each target snow layer, to thereby replenish a certain amount of water into each target snow layer in the snow block to be prepared into ice-lick snow.

2. The ice-like snow preparation vehicle as claimed in claim 1, wherein an extension direction of a part of the plurality of water passages is the same as a length direction of the water dividing plate, and an extension direction of another part of the plurality of water passages is the same as a width direction of the water dividing plate;
wherein the part of the plurality of water passages are arranged on the water dividing plate in an array along the length direction of the water dividing plate; and the another part of the plurality of water passages are arranged on the water dividing plate in an array along the width direction of the water dividing plate; and
wherein a bottom surface of the water dividing plate defines a plurality of first mounting holes, each of the plurality of first mounting holes is configured to connect a corresponding one of the plurality of water injection pipes, and an end of each of the plurality of first mounting holes is connected to a corresponding one of the plurality of limiting holes, and another end of each of the plurality of first mounting holes is connected to a corresponding one of crossing areas formed by the part of the plurality of water passages in the width direction and the another part of the plurality of water passages in the length direction.

3. The ice-like snow preparation vehicle as claimed in claim 2, wherein one of the crossing areas on a middle area of the water dividing plate defines a second mounting hole, and a head end of the temperature-pressure sensing element is mounted in the second mounting hole; and
wherein the temperature-pressure sensing element is a temperature-pressure detecting rod;
and a difference d between a length of the temperature-pressure detecting rod and a length of each of the plurality of water injection pipes is greater than or equal to 10 cm and smaller than or equal to 20 cm.

4. The ice-like snow preparation vehicle as claimed in claim 1, wherein each of the plurality of water injection pipes comprises a pipe body and a water injection head fixed on a tail of the pipe body, and a peripheral side of a part of the pipe body proximate to the water injection head is covered with a thermal insulation element; and
wherein a surface of the water injection head defines a plurality of water injection holes, and a diameter d of an opening of each of the plurality of water injection holes is greater than or equal to 0.2 mm and small than or equal to 0.5 mm.

5. The ice-like snow preparation vehicle as claimed in claim 4, wherein the water injection head comprises a cylindrical section and a tip section connected to an end of the cylindrical section, and a diameter of the cylindrical section is greater than that of the thermal insulation element.

6. The ice-like snow preparation vehicle as claimed in claim 1, wherein a shape of a head of the temperature-pressure sensing element is conical.

7. An ice-like snow preparation final assembly, comprising a snow compactor and the ice-like snow preparation vehicle as claimed in claim 1, wherein the ice-like snow preparation vehicle is configured to move to a specified location driven by the snow compactor.

8. A calculation method of a water amount injected into a target position by an ice-like snow preparation vehicle, applied to the ice-like snow vehicle as claimed in claim 1; wherein the calculation method comprises:
calculating a hardness value of each target snow layer in the snow block to be prepared into ice-like snow according to the pressure of each target snow layers in the snow block to be prepared into ice-like snow;
calculating a density of each target snow layer in the snow block to be prepared into ice-like snow according to the hardness value of each target snow layer in the snow block to be prepared into ice-like snow using a formula expressed as follows:
$$ρ = ( P + 685.16 ) / 2.5058 \times 1 {0}^{3} ;$$
wherein P represents the hardness value of each target snow layer in the snow block to be prepared into ice-like snow, and ρ represents the density of each target snow layer in the snow block to be prepared into ice-like snow;
calculating a theoretical water replenishment rate of each target snow layer in the snow block to be prepared into ice-like snow according to the density of each target snow layer in the snow block to be prepared into ice-like snow using a formula expressed as follows:
$$R = \frac{{ρ}_{ice} - ρ}{{ρ}_{water}} ;$$
wherein ρ_{ice} represents an expected density of each target snow layer in the snow block to be prepared into ice-like snow; ρ_{water} represents a density of water; and R represents the theoretical water replenishment rate of each target snow layer in the snow block to be prepared into ice-like snow; and
calculating a theoretical water replenishment amount of each target snow layer in the snow block to be prepared into ice-like snow.

9. The calculation method of the water amount injected into the target position by the ice-like snow preparation vehicle as claimed in claim 8, further comprising:
calculating an actual water replenishment rate of each target snow layer in the snow block to be prepared into ice-like snow according to a temperature of each target snow layer in the snow block to be prepared into ice-like snow obtained by the temperature-pressure sensing element using a formula expressed as follows:
$$\{ \begin{matrix}{R}_{i}^{′} = 1.2 {R}_{i} & i = 1 \\ {R}_{i}^{′} = {R}_{i} - {aR}_{i - 1} \frac{{T}_{w}}{{T}_{w} - {T}_{i}} & i > 1\end{matrix} ;$$
wherein
$${R}_{i}^{′}$$
represents an actual water replenishment rate of an i^{th} target snow layer, Rᵢ represents a theoretical water replenishment rate of the i^{th} target snow layer, T_{w} represents a water injection temperature, Tᵢ represents a temperature of the i^{th} target snow layer, and a represents an empirical coefficient.

10. The calculation method of the water amount injected into the target position by the ice-like snow preparation vehicle as claimed in claim 9, further comprising:
calculating a water replenishment amount of each target snow layer in the snow block to be prepared into ice-like snow according to a product of the actual water replenishment rate of each target snow layer in the snow block to be prepared into ice-like snow and a volume of each target snow layer in the snow block to be prepared into ice-like snow.
